(19) United States
(12) Patent Application Publication
(10) Pub. No.: US 2008/0218901 A1
(43) Pub. Date: Sep. 11, 2008

(54) System and Method to Display Information on a Data Storage Cartridge

(75) Inventors: Nils Haustein, Soergenloch (DE); Craig Anthony Klein, Tucson, AZ (US); Daniel James Winarski, Tucson, AZ (US)

Correspondence Address: INTERNATIONAL BUSINESS MACHINES CORPORATION, 9000 SOUTH RITA ROAD, TUCSON, AZ, 85744, US

(73) Assignee: INTERNATIONAL BUSINESS MACHINES CORPORATION, Armonk, NY (US)

(21) Appl. No.: 12/059,545

(22) Filed: Mar. 31, 2008

(51) Int. Cl. G11B 15/68

(52) U.S. Cl. 360/90

(57) ABSTRACT

A method and a system are provided for displaying information on a data storage cartridge. The data storage cartridge includes a driver circuit coupled to a display and a cartridge memory. The driver circuit activates the display on the data storage cartridge. In response to the activation of the display on the data storage cartridge the driver circuit obtains information from the cartridge memory of the data storage cartridge. The driver circuit displays at least a portion of the information obtained from the cartridge memory on the display of the data storage cartridge. In one embodiment the data storage cartridge is a tape cartridge.

### FIELD OF THE INVENTION

This invention relates to data storage cartridges, and more particularly, a system and a method for displaying information related to a data storage cartridge.

### BACKGROUND OF THE INVENTION

Magnetic tape provides a means for physically storing data which may be archived or which may be stored in storage shelves of automated data storage libraries, or other storage locations such as a shelf, room, or vault. It is often desirable for the user to know information about a tape cartridge such as the content of data that is stored on the tape cartridge and the usage context of the tape cartridge.

Data content may include a description of the data content including the data set names, a directory index or table, file names of the data files, error history of the data, the application and/or format the data is stored in on the tape cartridge, the creator of the data, the data and/or time of the last access to the data on the tape cartridge, the date and/or time of the last write of data on the tape cartridge, the user name, system name, or application name of the last read and/or write to the tape cartridge, as well as other attributes pertaining to data.

The usage context may include whether the tape cartridge is rewritable or write-once, read many (WORM), whether the tape cartridge is a data tape cartridge or a cleaner tape cartridge, whether the tape cartridge is a member of a set such as a Redundant Array of Independent Tape (RAIT), whether the tape cartridge is used for backup or archive and instructions on how to read the data and/or how to process the data in order to make it human readable.

When the magnetic tape is stored within an automated data storage library, a user may obtain information about the magnetic tape cartridge by having a library accessor or picker go to the slot within the library containing the specific tape cartridge and reading the cartridge memory of the tape cartridge wirelessly. The library accessor or picker is capable of performing the reading of the cartridge memory without physically grasping the tape cartridge or placing the tape cartridge into a tape drive.

However, magnetic tapes used for archiving or backup are often stored external to the automated data storage library (e.g. on a shelf, in a room, or in a vault). When the magnetic tape is stored external to the automated data storage library, the user may only be able to obtain information about the tape cartridge based on labels (i.e. adhesive paper or stickers) that may have been affixed to the tape cartridge. The labels have a fixed capacity for information and allow only a limited description about the tape cartridge. For example a label may include a cartridge identifier (e.g. a volume serial number, VOLSER). To obtain meaningful information regarding the tape cartridge, such as the data content of the tape cartridge the user must map the cartridge identifier against the data content of the tape cartridge utilizing an application such as an inventory index. The application is an extra repository kept in addition to the tape cartridge, and provides search capabilities for the tape cartridge based on the data content and/or usage context of the tape cartridge. This repository might be implemented on paper or in an electronic fashion, such as in a database. In some instances of long-term archiving the repository may become unavailable due to, for example, a tape product becoming obsolete or a disaster. In some situations the loss of a repository means that the tape cartridge information is lost completely. Nevertheless, in situations where the repository is still available, the mapping of the cartridge identifier against its content of the tape cartridge can be a time consuming and tedious task that is prone to human error.

While in some cases the aforementioned labels may include more descriptive information other than the VOLSER, such as information about the data content and usage context of the tape cartridge, the additional descriptive information is limited by the size and available space remaining on affixed label.

Additionally labels affixed to tape cartridges are prone to human error. For example, the label may be unreadable either because of fading, stains, wear, abrasion, or poor penmanship. In addition, labels may fall off and the information about the tape cartridge may be lost. Finally, in order for the label to maintain up-to-date information the label must be updated manually by a user on a regular basis. The need for regular updates exposes the process to human error since the regular updates may be overlooked, such that the label retains out of date information. In addition, the fixed capacity of the label may not allow regular updates to be recorded.

Therefore an efficient and reliable system and method is needed to allow thorough human readable information about the data content and usage context of a data storage cartridge.

### SUMMARY OF THE INVENTION

A method and a system are provided for displaying information on a data storage cartridge. The data storage cartridge includes a driver circuit coupled to a display and a cartridge memory. The driver circuit activates the display on the data storage cartridge. In response to the activation of the display on the data storage cartridge the driver circuit obtains information from the cartridge memory of the data storage cartridge. The driver circuit displays at least a portion of the information obtained from the cartridge memory on the display of the data storage cartridge. In one embodiment the data storage cartridge is a tape cartridge.

In one embodiment the data storage cartridge further comprises a control coupled to the driver circuit. The driver circuit detects that the control has been engaged a first time and, in response, activates the display. The control may be one of a switch, a button, a toggle, a knob, or a lever. In one embodiment the control is a four-way button. In a further embodiment, the driver circuit powers on the display.

In one embodiment the information may include at least one of manufacturing information of the tape cartridge, a serial number of the tape cartridge, a date of a last write to the tape cartridge, a time of a last write to the tape cartridge, a date of a last read to the tape cartridge, a time of a last read to the tape cartridge, a user name, system name, or application name of a last write to the tape cartridge, a user name, system name or application name of a last read of the tape cartridge, data set names of data stored on the tape cartridge, a directory index or table of data stored on the tape cartridge, file names of data stored on the tape cartridge, error history of data stored on the tape cartridge, a backup status of data stored on the tape cartridge, an application format of data stored on the tape cartridge, and an archive status of data stored on the tape cartridge.

In another embodiment, the driver circuit determines if the control is engaged at a second time, and in response to determining that the control is not engaged at the second time, the driver circuit powers off the display. The second time is greater than a predetermined time threshold time after the first time. In one embodiment the predetermined threshold time may be determined by a user.

Finally, in one embodiment, the driver circuit obtains information by reading data from the cartridge memory. In one embodiment the driver circuit causes the display to display information comprising a message indicating that the data is not available in response to determining that the cartridge memory does not contain the data. In one embodiment the display is an OLED display. In a further embodiment the tape cartridge has a battery.

### BRIEF DESCRIPTION OF THE DRAWINGS

FIG. 1 is an illustration of a tape cartridge and tape reel of the prior art;

FIG. 2 is an illustration of a tape cartridge with a display according to the present embodiment;

FIG. 3 is a generalized block diagram of a computing environment in which a tape cartridge and a tape drive are implemented;

FIG. 4 is an example of a read buffer command according to the present embodiment;

FIG. 5 is an example of a write buffer command according to the present embodiment;

FIG. 6 is a process for displaying tape cartridge information according to the present embodiment.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

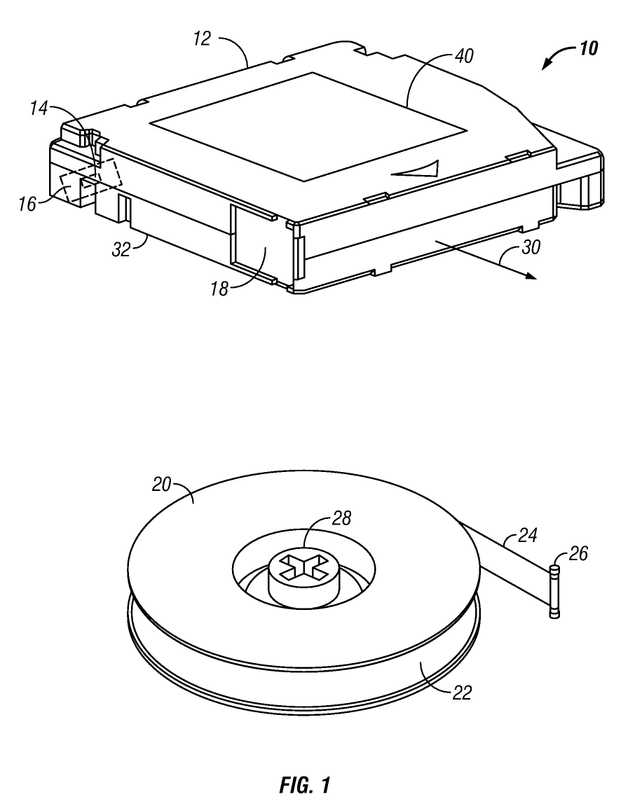

FIG. 1 illustrates a prior art LTO (Linear Tape Open) tape cartridge 10, which is a single-reel tape cartridge. The tape cartridge 10 comprises an exterior cartridge shell 12 which encloses and physically protects tape reel 20. The cartridge further includes cartridge memory 14 which is mounted onto a printed circuit board (PCB) 16, which is used to store information about the cartridge and information about the data content or the usage context of tape cartridge 10 (e.g. tape cartridge manufacturing information, VOLSER, error history, directory table, whether the cartridge is rewritable or WORM, and whether the cartridge is a data tape cartridge or a cleaner-tape cartridge, etc.). In addition, the cartridge memory 14 may comprise electrical contacts to allow the automated data storage library and/or data storage drive to access the contents of the cartridge memory 14. Alternatively, the cartridge memory 14 may comprise a contactless interface based on induction, radio frequency, or optical. In one embodiment, the cartridge memory comprises an RFID transmitter and receiver and an RFID antenna. As shown in FIG. 1, in one embodiment, the cartridge memory 14 is mounted in tape cartridge 10 at approximately a forty-five degree angle with respect to the bottom surface 32 of tape cartridge shell 12. Cartridge memory 14 is read from, and written to, wirelessly by a tape drive (not shown) or robotic picker of the library (not shown), via RFID, according to prior art methods. The robotic picker may also be referred to as a robotic accessor within the art.

As shown in FIG. 1, tape cartridge 10 also includes sliding door 18, which is slid open when tape cartridge 10 is inserted into a tape drive (not shown). Sliding door 18 is normally closed when tape cartridge 10 is not in use, so that debris and contaminants do not enter tape cartridge 10 and degrade tape media 22. The direction that tape cartridge 10 is slid into tape drive is shown as direction 30.

Tape reel 20 is stored in tape cartridge 10. Brake button 28 prevents rotation of tape reel 20 when the tape cartridge 10 is not in the tape drive. The tape drive releases brake button 28 when tape cartridge 10 is inserted into tape drive, and allows the free rotation of tape reel 20. Tape reel 20 is wound with tape 22, such as magnetic tape, magneto-optical tape, optical phase-change tape, or an equivalent medium. On the free end of tape 22 is an optional leader tape 24, and an optional leader pin 26 which is used to thread tape 22 through the tape drive (not shown) to a take-up reel (not shown) for reading and writing data.

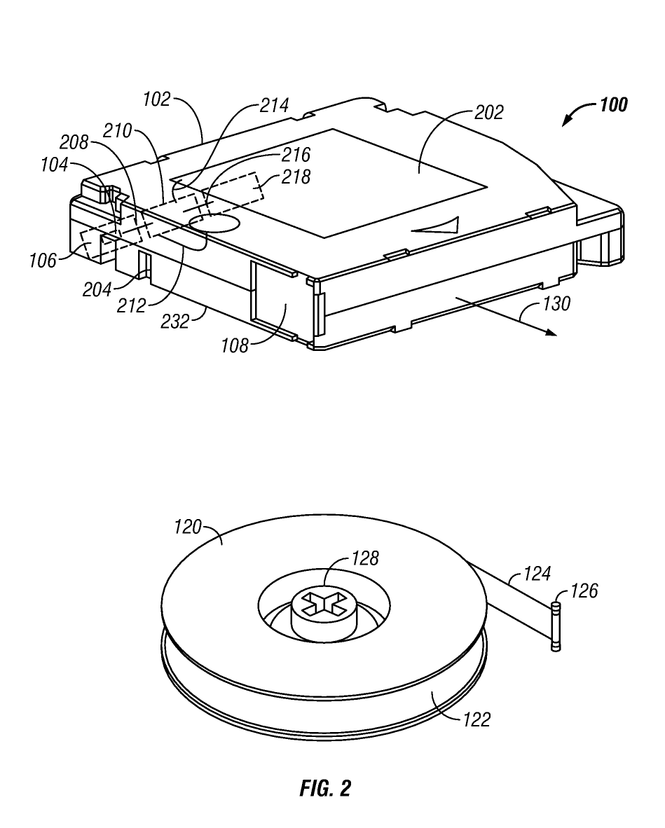

FIG. 2 illustrates LTO tape cartridge 100, including an organic light emitting diode (OLED) display 202 affixed to the top of cartridge shell 102 in accordance with the present embodiment. The exterior cartridge shell 102 encloses and physically protects tape reel 120. The cartridge further includes cartridge memory 104 mounted on a printed circuit board (PCB) 106, which is used to store information about the cartridge such as data content and usage context.

Data content may include a description of the data content such as the data set names, a directory index or table, file names of the data files, an error history of the data stored on tape cartridge 100, the application and/or format the data is stored in on the tape cartridge 100 (e.g. a word processing application such as Microsoft Word, Lotus Word Pro, or WordPerfect; a spreadsheet such as Microsoft Excel, WordPerfect Office Quattro Pro, or Lotus SmartSuite Lotus 123; and presentation programs such as Microsoft PowerPoint, Lotus SmartSuite Freelance Graphics, etc.). Data content may also include tape cartridge manufacturing information, the volume serial number of the tape cartridge (VOLSER), the creator of the data, the date and/or time of the last write to the tape media 122 of tape cartridge 100, the date and/or time of the last read or access of data on the tape media 122 of tape cartridge 100, the user name, system name, or application name of the last write to tape media 122 of tape cartridge 100, the user name, system name or application name of the last read of the tape media 122 of tape cartridge 100, as well as other attributes pertaining to data.

The usage context of tape cartridge 100 may include whether the tape cartridge is rewritable or write once, read many (WORM), whether the tape cartridge 100 is a data tape cartridge or a cleaner tape cartridge, whether the tape cartridge 100 is a member of a set such as a Redundant Array of Independent Tape (RAIT), whether the tape cartridge 100 is used for backup or archive. The tape cartridge information displayed on the OLED display 202 may further include readable information and instructions on how to read the data and/or how to format the data to make the data human readable and, thus, understandable. In one embodiment the information regarding how to read the data may reference a tape drive system that is required to read the data. The usage context may further include information on what command set is used to read data such (e.g. the SCSI-3 command set). In addition, the usage context may include information about the block size and the data-structure of the data stored on the tape cartridge. In another embodiment the information may include the source code of a sample program that allows the user to read the data. The information to make the data human readable includes instructions or information about the format or of the data and information about a system or application required to properly format the data such that it human readable. Similarly, the information may include sample source code which can be used to make the data properly formatted and thus, human readable.

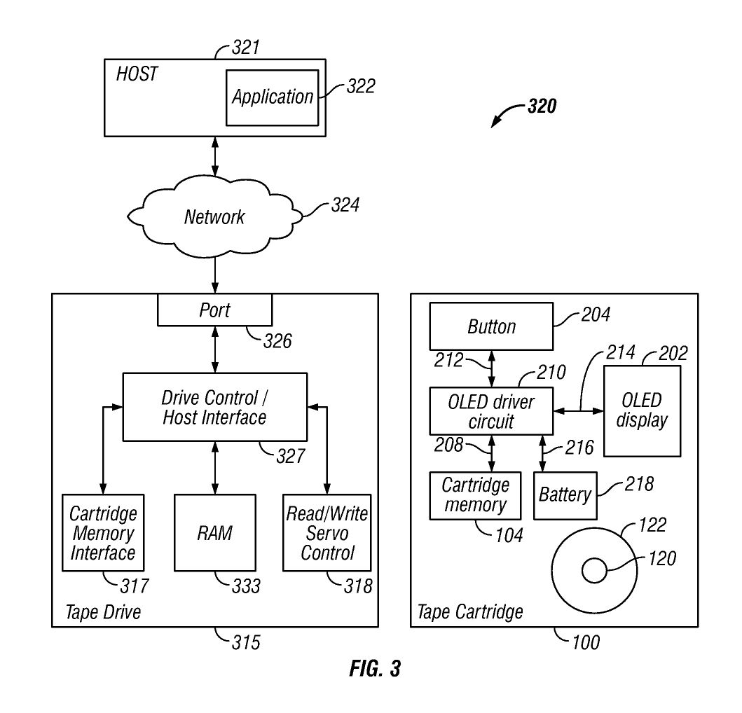

As shown in FIG. 2, in one embodiment, the cartridge memory 104 is mounted in tape cartridge 100 at approximately a forty-five degree angle with respect to the bottom surface 232 of tape cartridge shell 102. In addition, the cartridge memory 104 may comprise electrical contacts to allow the automated data storage library and/or tape drive 315 (as shown in FIG. 3) to access the contents of the cartridge memory 104. Alternatively, the cartridge memory 104 may comprise a contactless or wireless interface based on induction, radio frequency, or optical. In one embodiment, the cartridge memory comprises an RFID transmitter and receiver and an RFID antenna. The cartridge memory 104 may be read from, and written to, wirelessly by a tape drive 315 or library picker (not shown), via RFID, according to prior art methods.

Tape cartridge 100 also includes sliding door 108, which is slid open when tape cartridge 100 is inserted into a tape drive 315. Sliding door 108 is normally closed when tape cartridge 100 is not in use, so that debris and contaminants do not enter tape cartridge and degrade tape media 122. The direction that tape cartridge 100 is slid into tape drive 315 is shown as direction 130.

Tape reel 120 is stored in tape cartridge 100. Brake button 128 prevents rotation of tape reel 120 when the tape cartridge 100 is not in the tape drive 315. The tape drive 315 releases brake button 128 when tape cartridge 100 is inserted into tape drive 315, and allows the free rotation of tape reel 120. Tape reel 120 is wound with tape 122, such as magnetic tape, magneto-optical tape, optical phase-change tape, or an equivalent medium. On the free end of tape 122 is an optional leader tape 124, and an optional leader pin 126 which is used by tape drive 315 to thread the tape 122 through tape drive 315 for the purposes of data I/O.

Examples of magnetic tape cartridges comprise a cartridge based on LTO (Linear Tape Open) technology, such as the IBM TotalStorage LTO Ultrium Data Cartridge, and a cartridge based on IBM's 3592 technology, such as the IBM 3592 Enterprise Tape Cartridge. As will be appreciated, the tape cartridge 100 may be a magnetic tape cartridge having dual reels (in which the tape is fed between reels within the cartridge) such as the IBM 3570 tape cartridge or single reel cartridges, such as illustrated in FIG. 2, in which the tape media 122 is wound on a reel 120 within the tape cartridge 100. For a single-reel tape cartridge, when the tape cartridge 100 is loaded, the tape is fed between the cartridge reel and a take up reel (not shown) resident within the tape drive (not shown). While exemplary tape cartridges based on the LTO and 3592 formats have been described, it will be appreciated that the description is not limited by tape format. Examples of other tape formats include DLT, SDLT, SUN/STK 9840, SUN/STK 9940, SUN/STK T10000, Sony AIT, IBM 3590 and the like. Furthermore, it should be noted, some tape formats do not include cartridge memories (e.g. IBM 3590) while others have a cartridge memory requiring electrical contact, and still others have a cartridge memory which is not at 45 degree angle with respect to the bottom surface of the tape cartridge shell 102.

As shown in FIG. 2, the present embodiment implements OLED technology for display of tape cartridge information by affixing an OLED display 202 on tape cartridge 100. The tape cartridge information may include data content and usage context of the tape cartridge 100. For example the tape cartridge information may include data set names, a directory index or table, file names of the data files, and error history of the data stored on tape cartridge 100, the application and/or format the data is stored in on the tape cartridge 100, tape cartridge manufacturing information, the volume serial number of the tape cartridge (VOLSER), the creator of the data, the date and/or time of the last write and/or read of the tape media 122 of tape cartridge 100, the user name, system name, or application name of the last write and/or read of tape media 122 of tape cartridge 100, whether the tape cartridge 100 is rewritable or write-once, read many (WORM), whether the tape cartridge 100 is a data tape cartridge or a cleaner tape cartridge, whether the tape cartridge 100 is a member of a set such as a Redundant Array of Independent Tape (RAIT), whether the tape cartridge 100 is used for backup or archive, etc., as more fully described above.

OLED technology may be implemented with very thin architecture (e.g. less than 1 mm), thus allowing it to be affixed to tape cartridge shell 102 without changing the dimensions of the tape cartridge 100 appreciably. While not shown in FIG. 2, tape cartridge shell 102 may include a recessed portion, similar to recessed portion 40 shown in FIG. 1. In the prior art, paper labels are commonly affixed to the recessed portion 40. In one embodiment of the present disclosure the OLED display 202 is affixed to a pre-existing recessed portion (not shown) similar to the recessed portion 40 of tape cartridge shell 12 of FIG. 1. Since the OLED display 202 is affixed to the tape cartridge in the recessed region previously utilized by the prior art for a label, the external dimensions of the tape cartridge remain substantially unchanged. In one embodiment the OLED display 202 may be encapsulated by a transparent plastic substrate providing durability, flexibility and a low cost.

Tape cartridge 100 includes a control 204 to manually and temporarily power-on OLED display 202 for the display of tape cartridge information. Control 204 is illustrated in FIG. 2, and discussed herein as a button, however, it should be understood that control 204 may also be implemented as a switch, toggle, knob, or any other sensor capable of detecting a users input to manually and temporarily power-on OLED display 202 for the display of information. In one embodiment, the user may press button 204 (or engage other control into an “on” position) for a period of time to scroll the information displayed. In an additional embodiment, button 204 may be implemented as a four-way button allowing the user to navigate in four directions.

An OLED driver circuit 210 is used to control the display and to display the tape cartridge information on OLED display 202. OLED driver circuit 210 includes a display driver logic, which enables the OLED driver circuit 210 to read information out the cartridge memory 104 via cartridge memory link 208. In addition, OLED driver circuit 210 has a button connection 212 to button 204 in order to sense the state of the button 204 (e.g. whether the button or any other control is pressed or engaged in any way) and to drive the scroll operations. OLED driver circuit 210 also has a display connection 214 to the OLED display 202 for transmitting signals to be displayed. In addition, the OLED driver circuit 210 comprises a battery 218 connected to OLED driver circuit 210 via battery connection 216 to provide power to the OLED display 202.

The OLED display 202 remains in a powered-off state unless button 204 is pressed (or another control is pressed or engaged to an “on” position). In one embodiment, the OLED display 202 and the OLED driver circuit 210 are preconfigured to remain in a powered-on state for a predetermined threshold amount of time. In one embodiment, the predetermined threshold time is determined by the user. Alternatively, predetermined threshold time may be determined by the manufacturer of the tape cartridge 100. The predetermined threshold time may be a matter of seconds, minutes, or hours, etc. For example the predetermined threshold time may be 20 seconds, such that if it is determined that 20 seconds have elapsed since button 204 (or another control) was last pressed, the OLED display 202 is automatically powered-off. In one embodiment, the predetermined threshold time may be set to zero seconds during shipment of tape cartridge 100 to prevent any unauthorized access to tape cartridge information.

Referring to FIG. 3, a computing environment is illustrated in which the tape cartridge 100 and tape drive 315 are implemented in combination with a host 321 as a cartridge handling system 320. One example implementation of such a cartridge handling system 320 would be a tape data storage system.

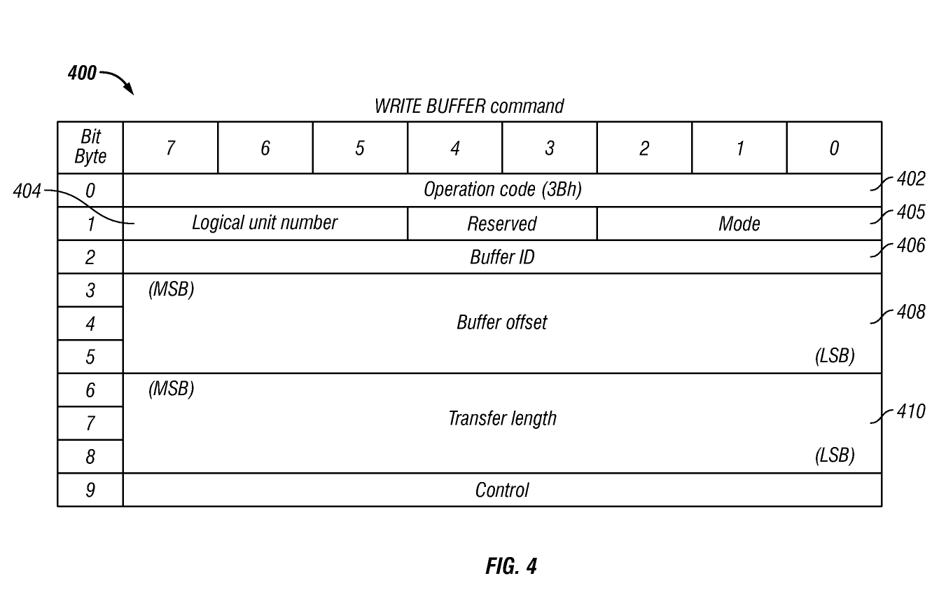

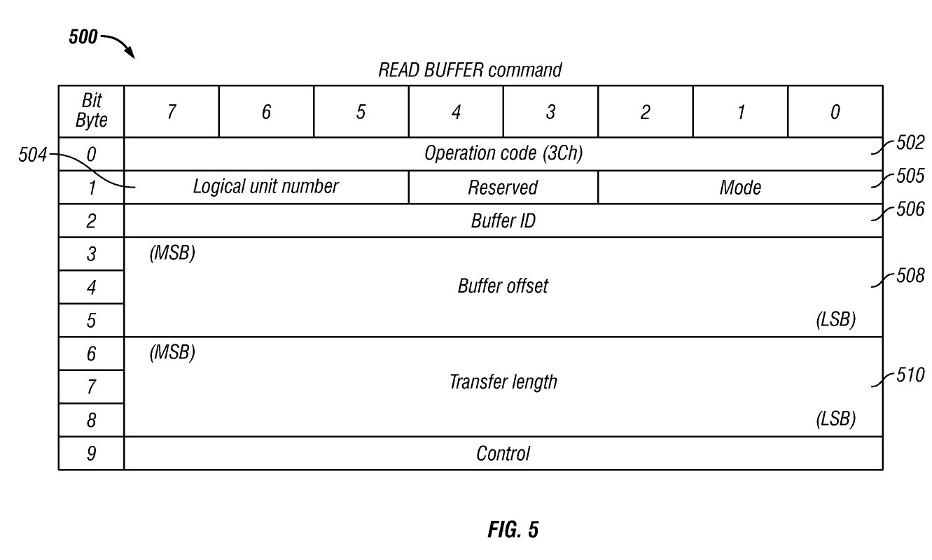

In the illustrated example, the host 321 includes a host application 322, such as a backup program, that transfers data to the tape drive 315 to sequentially write to the tape cartridge 100, such as by using the Small Computer System Interface (SCSI) tape commands such as the READ BUFFER command 400 (as shown in FIG. 4) and the WRITE BUFFER command 500 (as shown in FIG. 5) to communicate I/O requests to the tape drive 315, or any other data access command protocol known in the art.

As will be appreciated, the host 321 may be constructed from one or more servers, or alternatively, may be an IBM System-Z, System-I, System-P, or System-X host.

The tape drive 315 may connect with the host 321 through network 324. Network 324 may be based on fibre channel protocol (such as SCSI over fibre channel or IP over fibre channel) or network 324 may be based on Ethernet protocol (such as TCPIP, iSCSI or FCoE). It will be appreciated that the tape drive 315 may be enclosed within the host 321, or tape drive 315 may be a standalone unit connected across network 324, or resident in an automated data storage library (not shown) such as the IBM 3584 tape library.

In addition, a read/write servo drive system 318 is provided comprising a read/write head assembly used for reading information from, and writing information to, tape media 122. The read/write servo assembly includes read/write-elements for reading and writing data and read-elements for positioning the read/write head correctly on the tape media 122. The positioning of the read/write head correctly on the tape media 122 may be accomplished by timing-based-servo written onto tape media 122 by the manufacturer of tape cartridge 100.

A drive control system 327 in the tape drive 315 communicates with the cartridge memory interface 317 and the read/write system servo drive 318. Cartridge memory interface 317 of tape drive 315 is activated when a tape cartridge 100 including a cartridge memory 104 is inserted in the tape drive 315. To receive commands and exchange data for reading and writing the drive controller 327 controls host interface to communicate over one or more ports 326 with one or more hosts 321. The host interface 327 may be based on the SCSI-3 command set.

The tape cartridge information displayed on OLED display 202 comprises information stored in cartridge memory 104. The tape cartridge information may include data content and usage context of the tape cartridge 100. For example the tape cartridge information may include data set names, a directory index or table, file names of the data files, an error history of the data stored on tape cartridge 100, the application and/or format the data is stored in on the tape cartridge 100, tape cartridge manufacturing information, the volume serial number of the tape cartridge (VOLSER), the creator of the data, the date and/or time of the last write and/or read of the tape media 122 of tape cartridge 100, the user name, system name, or application name of the last write and/or read of tape media 122 of tape cartridge 100, whether the tape cartridge 100 is rewritable or write-once, read many (WORM), whether the tape cartridge 100 is a data tape cartridge or a cleaner tape cartridge, whether the tape cartridge 100 is a member of a set such as a Redundant Array of Independent Tape (RAIT), whether the tape cartridge 100 is used for backup or archive, etc.

In one embodiment, the tape cartridge memory 104 comprises a separate portion of cartridge memory 104 that is dedicated to store information to be displayed on OLED display 202. The cartridge memory 104, or this separate portion of cartridge memory 104, may be written with data by a host-resident application 322. In one embodiment, to ensure up-to-date information is stored in cartridge memory 104 of tape cartridge 100 the cartridge memory 104 is written with tape cartridge information upon each load and/or unloading of tape cartridge 100 in tape drive 315. In addition the user may specify what information is to be written to the cartridge memory allowing for customization of data to be displayed.

While tape cartridge 100 is loaded within tape drive 315, application 322 of host system 321 interacts with tape drive 315 using a protocol language (e.g. SCSI). In one embodiment the application 322 sends an appropriate SCSI command (e.g. the WRITE BUFFER command 500, as described further below with respect to FIG. 5) including the data to be displayed to tape drive 315 via network 324, such that specific requested data may be transmitted to the tape drive 315. The tape drive control/host interface 327 receives the WRITE BUFFER command 500 and the data to be displayed via port 326 and stores the data to be displayed on the OLED display to RAM 333. The tape drive control/host interface 327 of tape drive 315 subsequently interacts with cartridge memory 104 of tape cartridge 100 and writes the data from RAM 333 via RFID technology in cartridge memory interface 317 to the cartridge memory 104. In one embodiment the data is written to the separate portion of cartridge memory 104 dedicated for the OLED display 202. The OLED driver circuit 210 reads data from the cartridge memory 104 or the separate portion of cartridge memory and converts the data in cartridge memory 104 to displayable information and displays the information on the OLED display 202.

As shown in FIG. 4, the READ BUFFER command has a command code 402 of 3Ch (wherein h refers to hexadecimal, as is understood by one of ordinary skill in the art). The command is sent by an initiator (e.g. a host-resident application 322) to a target (e.g. tape drive 315 or a robotic picker within a library, both not shown) with the specified Logical Unit Number (LUN) 404. It should be understood by one of ordinary skill in the art that in each tape drive 315 may have its own SCSI connection within a library (e.g. an IBM 3584 library). All I/O and command read and/or write communications for a tape drive 315 are across LUN-0. Similarly, all command communications for a robotic picker (not shown) are across LUN-1. Accordingly, when the tape drive 315 receives read and/or write communications across LUN-1, the tape drive 315 sends the read and/or write communications to the robotic picker for execution. Therefore, the robotic picker (not shown) could receive a command to read the cartridge memory 104 of any tape cartridge 100 across LUN-1 of any tape drive 315 within the library.

Returning to FIG. 4, the mode parameter 405 is set to 010b (wherein b refers to binary) which indicates that there is a subsequent data transfer. The buffer ID 406 specifies a buffer within the tape drive 315 such as the cartridge memory 104, or the separate portion of cartridge memory 104 dedicated for the OLED display 202. In one embodiment, the buffer offset 408 specifies the offset within the buffer denoted by buffer ID 406 and can be 0h (wherein h refers to hexadecimal). The transfer length 410 denotes the number of bytes to be transferred from the tape drive 315 to the application in the subsequent DATA IN phase of SCSI protocol. The data transferred is stored in cartridge memory 104, or the separate portion of cartridge memory 104 dedicated for the OLED display 202. The data that is transferred is displayed on OLED display 202.

The SCSI WRITE BUFFER command 500 which can be used by the application to provide the displayable data to the cartridge memory 104 for OLED display 202 is shown in FIG. 5. The WRITE BUFFER command has a command code 502 of 3Bh (wherein h refers to hexadecimal). The command is sent by an initiator such as an application to a target such as a tape drive 315 with the specified Logical Unit Number 504. The mode parameter 505 shall be set to 010b (wherein b refers to binary) indicating that there is a subsequent data transfer. The buffer ID 506 specifies a buffer within the tape drive 315 such as the cartridge memory 104 or a portion of cartridge memory 104 that is used for the OLED display 202. In one embodiment the buffer offset 508 specifies the offset within the buffer denoted by buffer ID 506 and can be 0 h (wherein h refers to hexadecimal). The transfer length 510 denotes the number of bytes being transferred from the application (e.g. application 322) to the tape drive 315 in the subsequent DATA OUT phase according to SCSI protocol. The data transferred is stored in cartridge memory 104. In one embodiment the data transferred is stored in a portion of cartridge memory 104 dedicated for the OLED display 202.

The OLED driver circuit 210 reads data from the cartridge memory 104 or the separate portion of cartridge memory and converts the data in cartridge memory 104 to displayable information and displays the data on the OLED display 202. In one example, when button 204 is pressed, the OLED driver circuit 210 reads tape cartridge information out the cartridge memory 104 and transmits the data to OLED display 202 using the READ BUFFER command 400 as described above with respect to FIG. 4.

The present embodiment allows for including specific tape cartridge information to be displayed as requested by a user. The tape cartridge information may include data content and usage context of the tape cartridge 100. For example the tape cartridge information may include data set names, a directory index or table, file names of the data files, and error history of the data stored on tape cartridge 100, the application and/or format the data is stored in on the tape cartridge 100, tape cartridge manufacturing information, the volume serial number of the tape cartridge (VOLSER), the creator of the data, the date and/or time of the last write and/or read of the tape media 122 of tape cartridge 100, the user name, system name, or application name of the last write and/or read of tape media 122 of tape cartridge 100, whether the tape cartridge 100 is rewritable or write-once, read many (WORM), whether the tape cartridge 100 is a data tape cartridge or a cleaner tape cartridge, whether the tape cartridge 100 is a member of a set such as a Redundant Array of Independent Tape (RAIT), whether the tape cartridge 100 is used for backup or archive, etc.

For example, if a user is tasked with managing backup tapes the user may customize the settings of the OLED driver circuit 210 such that the OLED display 202 of tape cartridge 100 may display the date and time of a backup of the tape cartridge 100, as well as the system name, the user name, and the directory of all backed up objects. The user can immediately visually verify that the tape cartridge contains a data backup done after a specific time and for a specific system.

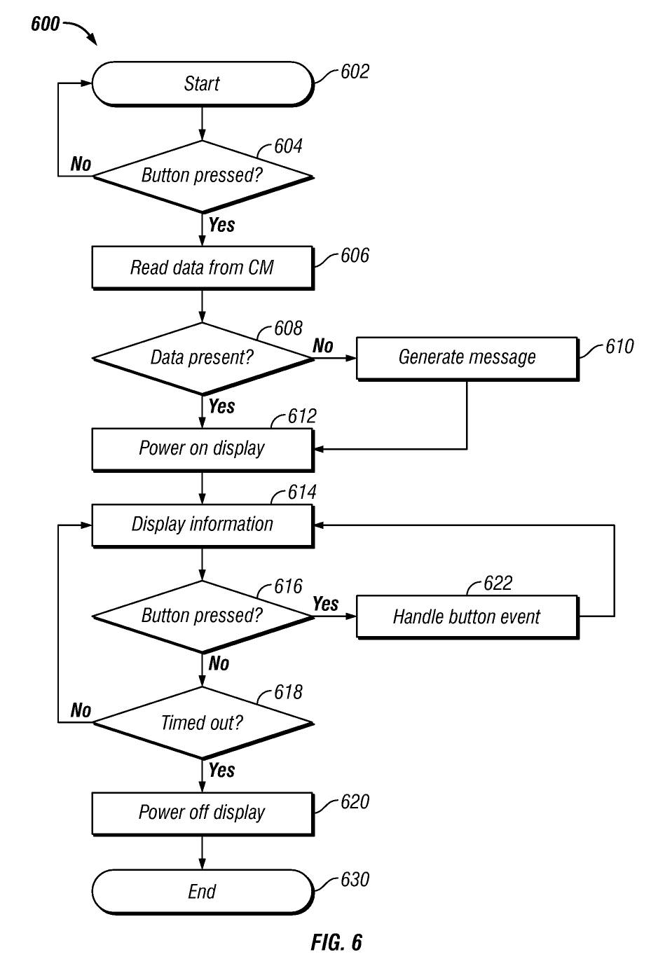

FIG. 6 shows the process of displaying tape cartridge information on an OLED display 202 on a tape cartridge 100. The process starts in step 602 and continues to step 604. In step 604, the OLED driver circuit 210 determines if the OLED display 202 has been activated. In one embodiment, the OLED driver circuit 210 determines if the OLED display 202 has been activated by determining if button 204 has been engaged at a first time (or another control is pressed or engaged in any way) through button connection 212.

If OLED driver circuit 210 determines the OLED display 202 has been activated (e.g. that the button 204 has been pressed or another control is pressed or engaged in any way) the process continues to step 606. If the OLED driver circuit 210 determines that the OLED display 202 has not been activated (e.g. the button 204 has not been pressed or another control is pressed or engaged in any way) the process flows back to step 602.

In step 606 the OLED driver circuit 210 obtains information from the cartridge memory 104. In one embodiment the OLED driver circuit 210 obtains information from the cartridge memory 104 by reading data from the cartridge memory 104. In step 608, the OLED driver circuit 210 determines if the cartridge memory 104 contains the requested data to be displayed. The OLED driver circuit 210 determines if the requested data is available by determining if the requested data is saved in cartridge memory 104. If the OLED driver circuit 210 determines that the cartridge memory 104 does contain the requested data to be displayed then the process continues to step 612. If the OLED driver circuit 210 determines that the cartridge memory 104 does not contain the requested data to be displayed then the process flows to step 610. It is important to note that while the cartridge memory 104 may not contain the requested data the step of reading data from the cartridge memory does indeed obtain information, namely that the cartridge memory does not contain the requested data. In step 610 the OLED driver circuit 210 generates a message indicating that the cartridge memory does not contain the requested data to be displayed. In step 612 the OLED driver circuit 210 powers on the OLED display 202 using power provided by battery 218.

In step 614 the OLED driver circuit 210 coverts the message generated in step 610 and/or the requested data in cartridge memory 104 read in step 606 to displayable information and displays the information on the OLED display 202. If the cartridge memory 104 does not contain the requested data a default message (generated in step 610) may be displayed (e.g. “status normal and operational”, “no data”, etc.) indicating that the requested data is not available. In one embodiment, if the cartridge memory 104 does not contain the requested data, in addition to the default message at least a portion of the data content of the tape cartridge 100 (e.g. a directory of contents of the tape cartridge) and/or the usage context of the tape cartridge 100 (e.g. whether the tape cartridge is archive, backup, mirror, WORM, etc.) that is available is displayed on OLED display 620.

In step 616, the OLED driver circuit 210 determines if button 204 is pressed at a second time (or another control is pressed or engaged in any way). If the OLED driver circuit 210 determines that the button 204 was pressed the process flows to step 622 where the button press event is handled. For example, the user may continue to press button 204. As mentioned above, in one embodiment, the user may press button 204 for a period of time to scroll the information displayed. Further, button 204 may be implemented as a four-way button allowing the user to scroll in four directions. The four-way button may be pressed up or down to allow scrolling up and down, respectively. In addition, the four-way button 204 may be pressed left or right to allow scrolling left and right. Scrolling allows images and messages to be displayed and subsequently read that are larger than the OLED display 202 can display at any one time. By allowing scrolling of an image more detail of the image may be displayed. The OLED driver circuit 210 determines the direction that the four-way button is being pressed in step 622 and applies the requested direction to the information being displayed as described in step 614. In one embodiment the four-way button 204 may be implemented as a toggle similar to the “eraser head” used in many keyboards of computer notebooks.

If the OLED driver circuit 210 determines that the button 204 was not pressed at a second time (or another control pressed or engaged in any way) the process flows to step 618 in which the OLED driver circuit 210 determines if the OLED display 202 has timed out. The OLED driver circuit 210 determines if the OLED display 202 has timed out by determining if the time that has elapsed is greater than the predetermined time threshold as discussed above. If the time elapsed since the button 204 was last engaged (e.g. a first time as described step 604) is less than the predetermined time threshold, the OLED display 202 has not timed out and the process returns to step 614 wherein the information continues to be displayed. If the time elapsed since the button 204 was last engaged (e.g. at a first time as described in step 604) is greater than the predetermined time threshold, the OLED display 202 has timed out and the process continues to step 620. In step 620, the OLED driver circuit 210 powers off the OLED display 202. Advantageously, the power of battery 218 within the OLED display 202 may be conserved with the inactivity timeout power off of step 620. The process ends at step 630.

Although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of the processes described herein may be performed in any order practical. Further, some steps may be performed simultaneously, in parallel, or concurrently. Moreover, some steps may be omitted. For example, in one embodiment, the display may be powered on (step 612 before the OLED driver circuit 210 reads data from the cartridge memory 104 (step 606).

Each of the blocks of the flow diagram of FIG. 6, and those depicted in subsequent figures, may be executed by a module (e.g., a software module) or a portion of a module or a computer system user. The methods described herein, the operations thereof and modules for performing such methods may therefore be executed on a computer system configured to execute the operations of the method and/or may be executed from computer-readable media. The method may be embodied in a machine-readable and/or computer-readable medium for configuring a computer system to execute the method. The software modules may be stored within and/or transmitted to a computer system memory to configure the computer system to perform the functions of the module. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Those skilled in the art will also recognize that the boundaries between modules and operations depicted herein are merely illustrative and alternative embodiments may merge such modules or operations, or impose an alternative decomposition of functionality thereon. For example, the actions discussed herein may be decomposed into sub-operations to be executed as multiple computer processes. Moreover, alternative embodiments may combine multiple instances of a particular operation or sub-operation. Furthermore, those skilled in the art will recognize that the operations described in exemplary embodiment are for illustration only. Operations may be combined or the functionality of the operations may be distributed in additional operations in accordance with the present embodiment. As will also be apparent to those of skill in the art, methods for determining delay and jitter described herein may employ other techniques (similar in effect to those described herein) to make such determinations, and such alternative techniques are intended to be comprehended by the methods and apparatus discussed herein.

As mentioned above, the predetermined threshold time may be determined by the user. Alternatively, the predetermined threshold time may be set by the manufacturer or the system administrator. During shipment the predetermined threshold time may be set to zero seconds, such that the OLED display 202 does not power on, thus, preventing any unauthorized reading of the data-content and usage context of the tape cartridge 100. Further, the predetermined threshold time may be a matter of seconds, minutes, or hours, etc. For example the predetermined threshold time may be 20 seconds, such that if it is determined that 20 seconds have elapsed since button 204 (or another control) was engaged, the OLED display 202 is automatically powered-off.

The described embodiment of an OLED display 202 affixed to a data storage cartridge, such as tape cartridge 100, allows for a human readable, up-to-date and reliable description of a tape cartridge 100, the data content and the usage context of the tape cartridge 100. The present embodiment ensures that the data content and usage context of a tape cartridge is available even when the tape cartridge is external to a library. Further the present embodiment eliminates the need for a repository. Therefore, during long term archiving the present embodiment ensures that the tape cartridge data content and usage context is not lost due the repository becoming unavailable. In addition, the tape cartridge information displayed on the OLED display 202 may include readable information and instructions on how to read the data and/or how to format the data to make the data visible. In one embodiment the information regarding how to read the data may reference a tape drive system that is required to read the data.

Since the OLED display is connected to cartridge memory 104 through cartridge memory link 208 the requested information may be determined without the use of an extra repository or a manual search (e.g. an application or an inventory index). Information, therefore, may be more efficiently obtained. In addition, upon on any load or unload of the tape cartridge 100 the cartridge memory 104 is updated assuring that the information displayed on OLED display 202 is up-to-date and reliable. Further, the update of tape cartridge information is much more time efficient since the labels no longer need to be updated manually by a user. The OLED display 620 also allows for additional information to be displayed as compared to the fixed amount that the prior art label would allow. The scrolling feature and the four-way button allow a user to navigate the displayed information to read all available information, as well as to see additional detail. Finally, the user may customize information displayed based on the user's individual needs or based on the data-content and/or the usage context of the tape cartridge 100.

Although the embodiments shown use magnetic tape cartridges, one skilled in the art will recognize the embodiments apply to optical disk cartridges, holographic cartridges, or other removable storage media and the use of either different types of cartridges or cartridges of the same type having different characteristics.

While particular embodiments of the present invention have been shown and described, it will be obvious to those skilled in the art that, based upon the teachings herein changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A method of displaying information on a tape cartridge comprising:
activating a display on said tape cartridge;
obtaining information from a cartridge memory within said tape cartridge in response to said activation of said display on said tape cartridge; and
displaying on a display on said tape cartridge at least a portion of said information obtained from said cartridge memory.

2. The method of claim 1, wherein said activating comprises detecting a control has been engaged at a first time.

3. The method of claim 2, wherein said control is one of a switch, a button, a toggle, a knob, or a lever.

4. The method of claim 3, wherein said control is a button and said button is a four-way button.

5. The method of claim 1, further comprising powering on said display.

6. The method of claim 1, wherein said display is an OLED display.

7. The method of claim 2, further comprising determining at a second time if said control is engaged, and in response to determining said control is not engaged, powering off said display, wherein said second time is greater than a predetermined time threshold time after said first time.

8. The method of claim 7, wherein said predetermined threshold time is determined by said user.

9. The method of claim 1, wherein obtaining information further comprises reading data from said cartridge memory.

10. The method of claim 9, wherein in response to said determining that said cartridge memory does not contain said data, displaying a message indicating said data is not available.

11. The method of claim 1, wherein said information is at least one of manufacturing information of said tape cartridge, a serial number of said tape cartridge, a date of a last write to said tape cartridge, a time of a last write to said tape cartridge, a date of a last read to said tape cartridge, a time of a last read to said tape cartridge, a user name, system name, or application name of a last write to said tape cartridge, a user name, system name or application name of a last read of said tape cartridge, data set names of data stored on said tape cartridge, a directory index or table of data stored on said tape cartridge, file names of data stored on said tape cartridge, error history of data stored on said tape cartridge, a backup status of data stored on said tape cartridge, an application format of data stored on said tape cartridge, and an archive status of data stored on said tape cartridge.

12. A tape cartridge comprising:
a display;
a cartridge memory;
a driver circuit coupled to said display and said cartridge memory, wherein said driver circuit is configured to:
activate said display on said tape cartridge;
obtain information from said cartridge memory of said tape cartridge in response to said activation of said display on said tape cartridge; and
display at least a portion of said information obtained from said cartridge memory on said display of said tape cartridge.

13. The tape cartridge of claim 12, further comprising a control coupled to said driver circuit, wherein said driver circuit is configured to perform said activation by detecting said control has been engaged at a first time.

14. The tape cartridge of claim 13, wherein said control is one of a switch, a button, a toggle, a knob, or a lever.

15. The tape cartridge of claim 14, wherein said control is a button and said button is a four-way button.

16. The tape cartridge of claim 12, wherein said driver circuit is further configured to power on said display.

17. The tape cartridge of claim 12, wherein said display is an OLED display.

18. The tape cartridge of claim 13, wherein said driver circuit is further configured to determine if said control is engaged at a second time, and in response to determining said control is not engaged said driver circuit is configured to power off said display, wherein said second time is greater than a predetermined time threshold time after said first time.

19. The tape cartridge of claim 18, wherein said predetermined threshold time is determined by said user.

20. The tape cartridge of claim 12, wherein said driver circuit is configured to obtain information by reading data from said cartridge memory.

21. The tape cartridge of claim 20, wherein said driver circuit is configured to display information comprising a message indicating said data is not available in response to determining that said cartridge memory does not contain said data.

22. The tape cartridge of claim 12, wherein said information is at least one of manufacturing information of said tape cartridge, a serial number of said tape cartridge, a date of a last write to said tape cartridge, a time of a last write to said tape cartridge, a date of a last read to said tape cartridge, a time of a last read to said tape cartridge, a user name, system name, or application name of a last write to said tape cartridge, a user name, system name or application name of a last read of said tape cartridge, data set names of data stored on said tape cartridge, a directory index or table of data stored on said tape cartridge, file names of data stored on said tape cartridge, error history of data stored on said tape cartridge, a backup status of data stored on said tape cartridge, an application format of data stored on said tape cartridge, and an archive status of data stored on said tape cartridge.

23. The tape cartridge of claim 12, further comprising a battery.

24. A data cartridge comprising:
a display;
a cartridge memory;
a driver circuit coupled to said display and said cartridge memory, wherein said driver circuit is configured to:
activate said display on said data cartridge;
obtain information from said cartridge memory of said data cartridge in response to said activation of said display on said data cartridge; and
display at least a portion of said information obtained from said cartridge memory on said display of said data cartridge.
